(19) United States
(12) Patent Application Publication
(10) Pub. No.: US 2009/0273605 A1
(43) Pub. Date: Nov. 5, 2009

(54) Operation Checking Method in Information System, Operation Checking Program Therefor, Recording Medium, and Operation Checking System

(76) Inventor: Norihiko Takebayashi, Chiba (JP)

Correspondence Address: BACON & THOMAS, PLLC, 625 SLATERS LANE, FOURTH FLOOR, ALEXANDRIA, VA, 22314-1176, US

(21) Appl. No.: 11/658,909

(22) PCT Filed: Feb. 27, 2006
(86) PCT No.: PCT/JP2006/303571

§ 371 Date: Jun. 30, 2009

(51) Int. Cl. G09G 5/36

(52) U.S. Cl. 345/545; 711/E12.001

(57) ABSTRACT

An operation checking system in an information system due to automated reproduction of a screen operation has a function of converting screen operation data in accordance with a change in format of a screen or an input item, a function of converting a class name in accordance with a development language for creating an execution code of a program to be reproduced and an operating mode of the execution code, and a function of interpreting a source code of the target program to directly activate the execution code of an intermediate language mode.

### TECHNICAL FIELD

The present invention relates to an operation checking method in an information system due to automation of reproduction of a screen operation, an operation checking program for implementing the method, a computer-readable recording medium having the operation checking program recorded, and an operation checking system using the operation checking program for performing operation checking in the information system.

Particularly the invention relates to an operation checking method in an information system, an operation checking program therefor, a recording medium and an operation checking system, in which screen operation data obtained by acquiring a screen operation executed on a display device are stored in a storage device by use of a hardware-environment, a software environment and a target program before change of any one of the hardware environment, the software environment and the target program and the screen operation data are read from the storage screen after change of any one of the hardware environment, the software environment and the target program so that the screen operation is reproduced on the display device.

### BACKGROUND ART

In the background art, such an operation checking method and such an operation checking system in an information system may include an input log file for storing an input key to be inputted for checking of an operation, a standard result file for storing a standard result which results from the checking of the operation in a predetermined normal operating environment, a comparison portion for executing checking of the operation based on the input key from the input log file in another new operating environment and comparing a result of the checking in a predetermined operating stage with a standard result stored in the standard result file and corresponding to the operating stage, and a comparison result storage file for storing a result of the comparison by the comparison portion (for example, see Patent Document 1).

Patent Document 1: Japanese Patent No. 2765549 (pages 1-4, and FIGS. 1-2)

There are other products analogous to the operation checking method and the operation checking system, such as QuickTest Professional (registered trademark) by Mercury Interactive Japan KK, IBM Rational Robot (registered trademark) by IBM Japan, Ltd., etc.

### DISCLOSURE OF THE INVENTION

Problems that the Invention is to Solve

However, in such an operation checking method and such an operation checking system in an information system according to the background art, screen operation data recorded by manually executing a screen operation of a program whose operation should be checked (hereinafter referred to as “target program”) depend on a screen of the target program and a format of an input item. Therefore, whenever the screen or the input item format is changed, a screen operation has to be executed manually again to rerecord screen operation data. This leads to a problem that maintenance and management of screen operation data are troublesome.

Further, a class name of an input item varies according to the kind of development language which creates an execution code of a target program. Once a development language has been changed, any screen operation of the target program created by another development language after the change cannot be reproduced by use of screen operation data recorded before the change. It is therefore necessary to execute the screen operation manually again to rerecord the screen operation data. Thus, there is a problem that screen operation data cannot be reused.

In addition, when a screen operation is acquired or reproduced, there arises a problem as follows. That is, because the class name of an input item when the operating mode of the execution code is an intermediate language mode is different from that when the operating mode is an executable mode, screen operation data recorded in one of the operating modes cannot be used for reproducing the screen operation in the other operating mode. It is therefore necessary to execute the screen operation manually again to rerecord the screen operation data. Thus, screen operation data cannot be reused.

Further, a source code of the target program cannot be interpreted to activate an execution code of the intermediate language mode directly. It is therefore necessary to create an execution code of the executable mode from the source code of the target program and then activate the execution code afresh. Thus, there is a problem that operation checking cannot be performed directly from the development language, and the operation checking system cannot be used maneuverably.

For the above reasons, it is necessary to execute a screen operation manually and repeatedly to rerecord screen operation data. In addition, it is impossible to make maneuverable use of the operation checking system. Thus, there is a large obstacle to use of the operation checking system.

Of the present invention, configurations according to Claims 1 and 10-12 are aimed at providing a function of converting screen operation data in accordance with a change in format of an input item.

Configurations of the invention according to Claims 2 and 10-12 are aimed at providing a function of converting screen operation data when an object identifier of the input item has been changed, in addition to the aim of the configuration of the invention according to Claim 1.

Configurations of the invention according to Claims 3 and 10-12 are aimed at adding a class name as one of conditions to specify an input item as a subject of reproduction of a screen operation when the class name is included as a constituent element of first screen information, in addition to the aim of the configuration of the invention according to Claim 1.

Configurations of the invention according to Claims 4 and 10-12 are aimed at adding a class name as one of conditions to specify an input item as a subject of reproduction of a screen operation when the class name is included as a constituent element of screen operation data, in addition to the aim of the configuration of the invention according to Claim 1.

Configurations of the invention according to Claims 5 and 10-12 are aimed at providing a function of converting the class name in accordance with a development language creating an execution code of a target program and an operating mode of the execution code when the screen operation is reproduced, in addition to the aim of the configuration of the invention according to Claim 3.

Configurations of the invention according to Claims 6 and 10-12 are aimed at providing a function of converting the class name in accordance with a development language creating an execution code of a target program and an operating mode of the execution code when the screen operation is reproduced, in addition to the aim of the configuration of the invention according to Claim 4.

Configurations of the invention according to Claims 7 and 10-12 are aimed at providing a function of interpreting a source code of a target program to directly activate an execution code of an intermediate language mode, in addition to the aim of the configuration of the invention according to Claim 1.

Configurations of the invention according to Claims 8 and 10-12 are aimed at providing a function of converting screen operation data in accordance with a change of a format of a screen, in addition to the aim of the configuration of the invention according to Claim 1.

Configurations of the invention according to Claims 9 and 10-12 are aimed at providing a function of converting the screen operation data when an object identifier of the screen is changed, in addition to the aim of the configuration of the invention according to Claim 8.

### Means for Solving the Problems

In order to achieve the aforementioned aims, the configuration of the invention according to Claim 1 provides an operation checking method in an information system characterized by comprising the steps of:

performing one or both of the following processes at the time of creation or modification of the target program,

a process of storing, in first screen information, format data formed by acquiring an object identifier and item coordinates of an input item and attaching a new item unique identifier thereto, when the input item is added into a screen of the target program, and

a process of storing, in the first screen information, format data formed by listing up all input items of the target program, acquiring an object identifier and item coordinates of each input item and attaching a new item unique identifier thereto, when an external command is issued by a shortcut key pushed down in an input device or by pointing on the display device or when creation or modification of the target program is terminated;

storing, in the storage device, screen operation data formed by identifying format data having item coordinates coinciding with item coordinates of an input item from the first screen information, acquiring an item unique identifier of the format data and putting a kind of operation corresponding to the input item into a recording category, when the screen operation acquired at the time of acquisition of the screen operation is an operation aimed at the input item; and

specifying the input item as an input item to be subjected to reproduction of the screen operation by using an item unique identifier of the screen operation data for identifying format data having an item unique identifier coinciding with the item unique identifier of the screen operation data from the first screen information and by using item coordinates acquired from the format data as a subject of comparison for identifying an input item having item coordinates coinciding therewith from input items drawn on the display device, when a recording category of screen operation data read from the storage device at the time of reproduction of the screen operation shows an operation aimed at the input item.

The “software environment” herein means basic software such as an operating system or middleware, and the “target program” means software such as a business program, a utility, a tool, etc. which operates on the basic software.

Assume that the term “screen” used in the invention designates not a physical screen (generally known as screen) of the display device but a logical screen (generally known as form) such as a window, a dialog box or the like to be used in a general software development environment.

The “screen operation” means an operation performed upon a screen or an input item from the input device or on the display device.

The “input item” includes any item which is a subject of an operation by pushing down a shortcut key or by pointing, such as a text box, a list box, a check box, a button, a graphics image, etc. on a screen of the target program drawn on the display device. Assume that the contents of the operation are not limited to a so-called input but may include selection, instruction, etc. In the present invention, the input item may be referred to as “item” simply.

The “item unique identifier” (hereinafter referred to as “item UID”) designates an identifier of an input item serving uniquely in the target program.

The “item coordinates” designate a position (left corner, upper corner, right corner and lower corner) where an input item of a screen of the target program drawn on the display device is located in the screen.

The “screen operation data” designate data which describe the contents of a screen operation. The kind of the screen operation can be identified by a recording category. The “screen operation data” is also referred to as “test script” in the general examples in the background art.

The “item value” designates a text value, a list item value, a state of selection of a check box, a graphics image, etc. of an input item of a screen of the target program drawn on the display device.

In addition to the configuration of the invention according to Claim 1, the configuration of the invention according to Claim 2 is characterized by comprising the steps of:

identifying format data having an object identifier coinciding with a before-change object identifier of an input item from the first screen information and changing a value of the object identifier of the format data to a value of an after-change object identifier of the input item, when the object identifier of the input item is changed at the time of creation or modification of the target program; and

storing, in the first screen information, format data formed by listing up all input items of the target program, acquiring an object identifier and item coordinates of each input item, changing values of item coordinates of the format data into values of the item coordinates of the input item when format data having an object identifier coinciding with the acquired object identifier show an input item present in the first screen information, acquiring an object identifier and item coordinates of the input item when the format data show an input item absent in the first screen information, and attaching a new item unique identifier thereto, when the external command is issued at the time of creation or modification of the target program or when creation or modification of the target program is terminated.

The “item object identifier” (hereinafter referred to as “item OID”) mentioned herein designates an identifier of an object attached to an input item in the target program.

In addition to the configuration of the invention according to Claim 2, the configuration of the invention according to Claim 3 is characterized by comprising the steps of:

when a class name is included as a constituent element of the first screen information,
adding a class name of the added input item or class names of the listed input items into a configuration of the format data to be stored in the first screen information at the time of creation or modification of the target program; and

specifying the input item as an input item to be subjected to reproduction of the screen operation at the time of reproduction of the screen operation by using an item unique identifier of screen operation data read from the storage device for identifying format data having an item unique identifier coinciding with the item unique identifier of the screen operation data from the first screen information and by using item coordinates and a class name acquired from the identified format data as item coordinates and a class name to be compared for identifying an input item having item coordinates and a class name coinciding therewith from input items drawn on the display device.

Generally the term “class” designates an abstract superordinate concept in which concepts of “objects” in object-oriented technology are aggregated for each characteristic. A class is abstracted from objects, and each object realizes the class.

The term “object” in the invention is used exclusively as a screen or an input item drawn on the display device. In an environment of Windows (registered trademark) by Microsoft Corporation, the object is also referred to as “control”. Each control belongs to a specific class and has a “class name”. The control also has an “object identifier” for allowing itself to be identified uniquely.

In addition to the configuration of the invention according to Claim 1, the configuration of the invention according to Claim 4 is characterized by comprising the steps of:

when a class name is included as a constituent element of the screen operation data,

adding a class name of the acquired input item to be subjected to the screen operation into a configuration of the screen operation data to be stored in the storage device at the time of acquisition of the screen operation; and

specifying the input item as an input item to be subjected to reproduction of the screen operation at the time of reproduction of the screen operation by using an item unique identifier of screen operation data read from the storage device for identifying format data having an item unique identifier coinciding with the item unique identifier of the screen operation data from the first screen information and by using item coordinates acquired from the identified format data and a class name acquired from the screen operation data as item coordinates and a class name to be compared for specifying an input item having item coordinates and a class name coinciding therewith from input items drawn on the display device.

In addition to the configuration of the invention according to Claim 3, the configuration of the invention according to Claim 5 is characterized by comprising the steps of:

when a class name is included as a constituent element of the first screen information,

using a class name list composed of an individual class name of each input item at the time of creation and modification of the target program, an individual class name of the input item in one or both of operating modes of an execution code of the target program and a representative class name of the input item in accordance with each development language used for creating or modifying the target program and each input item of a screen of the target program;

using a class name of the added input item or a class name of each of the listed input items as an individual class name, identifying data having an individual class name coinciding therewith from a column of creation-time or modification-time individual class names in the class name list by using the individual class name, acquiring a representative class name of the identified data and using the acquired representative class name as a class name to be added to a configuration of format data to be stored in the first screen information, at the time of creation or modification of the target program; and

using a class name acquired from the format data as a representative class name, identifying data having a representative class name coinciding therewith from a column of representative class names in the class name list by using the representative class name, acquiring an individual class name from a column of reproduction-time individual class names in an operating mode of the execution code of the target program and using the acquired individual class name as a class name to be used as the class name to be compared, at the time of reproduction of the screen operation.

In addition to the configuration of the invention according to Claim 4, the configuration of the invention according to Claim 6 is characterized by comprising the steps of:

when a class name is included as a constituent element of the screen operation data,

using a class name list composed of an individual class name of each input item and a representative class name of the input item in one or both of operating modes of an execution code of the target program in accordance with each development language used for creating or modifying the target program and each input item of a screen of the target program;

using a class name of the acquired input item to be subjected to the screen operation as an individual class name, identifying data having an individual class name coinciding therewith' from a column of acquisition-time class names in an operating mode of an execution code of the target program in the class name list by using the individual class name, acquiring a representative class name of the identified data and using the acquired representative class name as a class name to be added to a configuration of screen operation data to be stored in the storage device, at the time of acquisition of the screen operation; and

using a class name acquired from the screen operation data as a representative class name, identifying data having a representative class name coinciding therewith from a column of representative class names in the class name list by using the representative class name, acquiring an individual class name from a column of reproduction-time individual class names in an operating mode of the execution code of the target program and using the acquired individual class name as a class name to be used as the class name to be compared, at the time of reproduction of the screen operation.

In addition to the configuration of the invention according to Claim 1, the configuration of the invention according to Claim 7 is characterized by comprising the steps of:

executing a first system specific command to acquire a path to a development language from a first system specific area and acquire a path to a source code of the target program from a second system specific area and executing a second system specific command by using the path to the development language and the path to the source code to instruct the software environment to activate the development language when the development language for creating an execution code of the target program has not been activated yet at the time of acquisition or reproduction of the screen operation; and

executing a third system specific command in the middle of display of the target program in the foreground of a screen to instruct the software environment to interpret the source code of the target program into the execution code to activate the execution code of the target program to use the execution code as a target program to be used at the time of acquisition or reproduction of the screen operation when the development language has been activated.

The “source code” mentioned herein designates an editable program code used for creating or modifying the target program. The “execution code” designates a program code used for executing the target program.

The “execution code” typically has two operating modes, that is, an intermediate language mode and an executable mode. The “intermediate language mode” is an operating mode of the execution code created when the source code of the target program is interpreted into the execution code. The “executable mode” is an operating mode of the execution code created when the execution code is generated from the source code of the target program.

The “development language” designates a program language used for creating or modifying the source code of the target program or for generating the execution code from the source code.

The “registry” designates a database for performing central control upon any setting information about the computer including hardware and applications in an environment of Windows (registered trademark) by Microsoft Corporation or the like.

In addition to the configuration of the invention according to Claim 1, the configuration of the invention according to Claim 8 is characterized by comprising the steps of:

performing one or both of the following processes at the time of creation or modification of the target program,

a process of storing, in second screen information, format data formed by acquiring an object identifier and a screen title of a screen and attaching a new screen unique identifier thereto when the screen is added to the target program, and

a process of storing, in the second screen information, format data formed by listing up all screens of the target program, acquiring an object identifier and a screen title of each screen and attaching a new screen unique identifier thereto when the external command is issued or when creation or modification of the target program is terminated;

storing, in the storage device, screen operation data formed by identifying format data having a screen title coinciding with a screen title of the screen from the second screen information by using the screen title of the screen, acquiring a screen unique identifier of the format data and putting the kind of operation corresponding to the screen into a recording category when the screen operation acquired is an operation aimed at a screen at the time of acquisition of the screen operation; and

specifying the screen as a target screen to be subjected to reproduction of the screen operation by using a screen unique identifier of the screen operation data for identifying format data having a screen unique identifier coinciding with the screen unique identifier of the screen operation data from the second screen information and by using a screen title acquired from the identified format data as a screen title to be compared for identifying a screen having a screen title coinciding therewith from screens drawn on the display device when a recording category of the screen operation data read from the storage device shows an operation aimed at a screen at the time of reproduction of the screen operation.

The “screen unique identifier” (hereinafter referred to as “screen UID”) mentioned herein designates an identifier of a screen serving uniquely in the target program.

The “screen title” designates a title of a screen displayed in a top position of the screen when the execution code of the target program has been activated and the screen has been drawn on the display device.

The “screen position” designates a display position (left corner or upper corner) of the screen when the execution code of the target program has been activated and the screen has been drawn on the display device.

In addition to the configuration of the invention according to Claim 8, the configuration of the invention according to Claim 9 is characterized by comprising the steps of:

identifying format data having an object identifier coinciding with a before-change object identifier of the screen from the second screen information by using the before-change object identifier of the screen and changing a value of the object identifier of the identified format data into a value of an after-change object identifier of the screen when the object identifier of the screen is changed at the time of creation or modification of the target program; and

storing, in the second screen information, format data formed by listing up all screens of the target program, acquiring an object identifier and a screen title with respect to each screen, changing a value of a screen title of the format data into a value of the screen title of the screen when format data having an object identifier coinciding with the acquired object identifier are present in the second screen information, acquiring an object identifier and a screen title of the screen when the format data are absent in the second screen information, and attaching a new screen unique identifier thereto, when the external command is issued at the time of creation or modification of the target program or when creation or modification of the target program is terminated.

The “screen object identifier” (hereinafter referred to as “screen OID”) mentioned herein designates an identifier of an object attached to a screen in the target program.

According to the configuration of the invention according to CCaim 10, there is provided an operation checking program for implementing an operation checking method in an information system according to any one of Claims 1 through 9.

According to the configuration of the invention according to Claim 11, there is provided a computer-readable recording medium in which an operation checking program according to Claim 10 is recorded.

According to the configuration of the invention according to Claim 12, there is provided an operation checking system characterized in that operation checking in an information system is made by using an operation checking program according to Claim 10.

### EFFECT OF THE INVENTION

In the configurations of the invention according to Claims 1-2 and 10-12, even if the format of an input item of a screen of a target program is changed, screen operation data recorded before the change can be converted to reproduce a screen operation in the target program after the change. Accordingly, it is not necessary to execute the screen operation manually again to rerecord the screen operation data. It will therefore go well if the screen operation data are recorded only once. Thus, it is possible to accelerate the use of the operation checking system largely and it becomes easy to maintain and manage the screen operation data.

In the configurations of the invention according to Claims 3-4 and 10-12, in addition to the effect of the configuration of the invention according to Claim 1, the accuracy of the conversion can be improved by use of a class name at the time of conversion of the screen operation data.

In the configurations of the invention according to Claims 5-6 and 10-12, in addition to the effect of the configurations of the invention according to Claims 3-4, even if a development language for creating an execution code of the target program is changed or the operating mode of the execution code is changed at the time of reproduction of the screen operation, a class name can be changed to reproduce the screen operation after the change. Accordingly, it is not necessary to execute the screen operation manually again to rerecord the screen operation data. It will therefore go well if the screen operation data are recorded only once. Thus, it is possible to accelerate the use of the operation checking system largely and it is possible to reuse the screen operation data and make effective use thereof.

In the configurations of the invention according to Claims 7 and 10-12, in addition to the effect of the configuration of the invention according to Claim 1, a source code of the target program can be interpreted so that the execution code of an intermediate language mode can be activated directly. It is therefore possible to execute operation checking immediately from a development language. Thus, it is possible to accelerate the use of the operation checking system largely and it is possible to make maneuverable use of the operation checking system.

In the configurations of the invention according to Claims 8-9 and 10-12, in addition to the effect of the configuration of the invention according to Claim 1, even if the format of the screen of the target program is changed, screen operation data recorded before the change can be converted so that the screen operation can be reproduced in the target program after the change. Accordingly, it is not necessary to execute the screen operation manually again to rerecord the screen operation data. It will therefore go well if the screen operation data are recorded only once. Thus, it is therefore possible to accelerate the use of the operation checking system largely and it becomes easy to maintain and manage the screen operation data.

### BEST MODE FOR CARRYING OUT THE INVENTION

FIG. 1 shows a typical configuration diagram of an operation checking system (apparatus) to be used for implementing an operation checking method in an information system according to the invention.

In FIG. 1, the reference numeral 1 represents an input device including a keyboard, a pointing device, etc.; 2, a display device including a display, etc.; 3, a storage device into or from which screen operation data are stored or read; 4, a control device for implementing the operation checking method; and 5, a recording means for storing control information required for implementing the operation checking method.

In another example than the illustrated one, the storage device 3 may be replaced by a storage area on a memory.

First screen information, second screen information, a class name list, etc. in the invention are stored in there cording means 5.

In another example than the illustrated one, the recording means 5 maybe placed in the storage device 3, or may be replaced by a storage area on a memory.

“Pushing down a shortcut key” in the input device 1 means an operation of pushing down a function key or pushing down a predetermined key such as a Ctrl key, a Shift key, an Alt key or the like together with another key in the keyboard in order to perform a predetermined screen operation.

“Pointing” on the display device 2 means an operation of designating the position or range of an input item or selecting an item value or the like on the display device 2 by means of a pointing device such as a mouse, a track pad, a track ball, etc.

Assume that the term “screen” used in the invention designates not a physical screen (generically known as screen) of the display device but a logical screen (generically known as form) such as a window, a dialog box or the like to be used in a development environment such as Visual Studio (registered trademark) by Microsoft Corporation or the like.

FIG. 2 shows a functional diagram of an operation checking system in an information system according to an embodiment of the invention. An acquisition-time target program 11 operates in a hardware environment, a software environment and the target program which have not been changed yet. A reproduction-time target program 15 operates after any one of the hardware environment, the software environment and the target program has been changed.

When a command to start acquisition of a screen operation is issued at the time of acquisition of the screen operation, a control portion 12 links the acquisition-time target program 11 with an acquisition portion 13. The acquisition portion 13 acquires an event such as a keyboard operation or a mouse operation occurring in the target program and writes a recording category corresponding to the kind of the event to arrange screen operation data. The acquisition portion 13 stores the screen operation data into the storage device 3. When a command to terminate the acquisition of the screen operation is issued, the control portion 12 cuts off the link between the target program 11 and the acquisition portion 13.

When a command to start reproduction of a screen operation is issued at the time of reproduction of the screen operation, the control portion 12 activates a reproduction portion 14. The reproduction portion 14 reads screen operation data from the storage device 3 and performs the screen operation on a screen of the reproduction-time target program 15. When reading the screen operation data from the storage device 3 is terminated, the reproduction portion 14 suspends its operation.

FIG. 13 shows a format of a test script in a general example in the background art. When an input item is a subject of an operation, the test script is composed of a recording category, an item value and item coordinates. When a screen is a subject of an operation, the test script is composed of a recording category, a screen position and a screen title. Due to the recording category, discrimination between an operation aimed at a screen and an operation aimed at an input item is made by the recording category.

FIG. 14 is a flow chart showing a method for acquiring a screen operation in a general example in the background art. The acquisition portion 13 in FIG. 2 operates in an event-driven mode. As soon as an event such as a keyboard operation or a mouse operation occurs in the acquisition-time target program 11, the acquisition portion 13 is activated to execute a process of FIG. 14.

In FIG. 14, when a screen is displayed initially (Step S101), “screen display” is written in the recording category, and the screen position and screen title of the screen are acquired to form a test script. The test script is stored in the storage device 3 (Step S102). Then, the processing of the event is terminated.

On the other hand, when a screen is displayed on and after the second time (Step S101), a judgment is made as to whether the screen where the event has occurred has undergone a change or not (Step S103).

When the screen has undergone a change, “item value input” is written in the recording category and the inputted item value and the item coordinates are acquired to form a test script if the item value inputted in the input item of the screen before the change has not been stored yet (Step S104). The test script is stored in the storage device 3 (Step S105). (When the item value has been already stored, nothing is done.) Next, “screen display” is written in the recording category and the screen position and screen title of the screen after the change are acquired to form a test script. The test script is stored in the storage device 3 (Step S106). Then, the processing of the event is terminated.

Alternatively, when the screen has not undergone any change (Step S103), a judgment is made as to whether the input item where the event has occurred has undergone a change or not (Step S107).

When the input item where the event has occurred has undergone a change, “item value input” is written in the recording category and the inputted item value and the item coordinates are acquired to form a test script if the item value inputted in the input item before the change has not been stored yet (Step S108). The test script is stored in the storage device 3 (Step S109). (When the item value has been already stored, nothing is done.) Next, the kind of the event which has occurred is judged (Step S110). When the event is a mouse operation, “mouse operation” is written in the recording category. When the input item where the event has occurred has an item value, the item value is acquired and the item coordinates of the input item are acquired to form a script. The test script is stored in the storage device 3 (Step S111). Then, the processing of the event is terminated.

On the other hand, when the input item where the event has occurred has not undergone any change, the kind of the event which has occurred is judged (Step S110). When the event is a mouse operation, “mouse operation” is written in the recording category. When the input item where the event has occurred has an item value, the item value is acquired and the item coordinates of the input item are acquired to form a test script. The test script is stored in the storage device 3 (Step S111). Then, the processing of the event is terminated.

FIG. 15 is a flow chart showing a method for reproducing a screen operation in a general example in the background art. The reproduction portion 14 in FIG. 2 reads test scripts one by one from the storage device 3 (Step S201) to perform the following process till there is no data to read (Step S202).

When the recording category of the read test script is “screen display” (Step S203), the reproduction portion 14 acquires a screen title of a screen drawn in the foreground (Step S204), and judges whether the acquired screen title coincides with the screen title of the test script or not (Step S205). The reproduction portion 14 waits for display of a screen having a screen title coinciding with the screen title of the test script.

When a screen having a screen title coinciding with the screen title of the test script is displayed (Step S205), the reproduction portion 14 uses the screen position of the test script to adjust the position of the displayed screen in agreement with the position of the screen when the screen operation was acquired (Step S206). Then, the reproduction portion 14 reads a test script to be processed next from the storage device 3.

When the recording category of the read test script is “mouse operation” or “item value input” (Step S203), the reproduction portion 14 uses the item coordinates of the test script to identify an input item having item coordinates coinciding therewith from displayed input items to thereby specify the identified input item as an input item to be reproduced (Step S207).

Subsequently when the recording category of the read test script is “mouse operation” (Step S208), the reproduction portion 14 executes a predetermined API function (for example, a Send Input command in an environment of Windows (registered trademark) by Microsoft Corporation) to operate the mouse in a pseudo manner with respect to the input item to be reproduced (Step S209).

On the other hand, when the recording category of the read test script is “item value input” (Step S208), the reproduction portion 14 executes a predetermined API function (for example, a Set Window Text command in an environment of Windows (registered trademark) by Microsoft Corporation) to input the item value of the test script into the input item to be reproduced (Step S210).

FIG. 3 shows formats of first screen information and second screen information according to an embodiment of the invention.

Format data of each input item to be stored in the first screen information has a configuration composed of an item UID, an item OID and item coordinates. A class name of the input item may be added to the configuration if necessary. Generally, there is no case where identical item coordinates are used on one and the same screen. Therefore, in this configuration, an input item to be reproduced can be specified in a single screen. In a plurality of screens, a screen UID may be added to the configuration in accordance with necessity so that an input item to be reproduced can be identified among the screens.

On the other hand, format data of each screen to be stored in the second screen information has a configuration composed of a screen UID, a screen OID and a screen title. Generally, there is no case where identical screen titles are used in one and the same target program. Therefore, in this configuration, a screen to be reproduced can be specified.

When the code system of the screen UID and the item UID is arranged so that discrimination between screen format data and input item format data can be made by the screen UID and the item UID, the formats of the configurations of the first screen information and the second screen information may be adjusted so that they can be integrated into one.

FIG. 4 shows formats of screen operation data according to an embodiment of the invention.

When an operation is aimed at an input item, screen operation data has a configuration composed of a recording category, an item UID and an item value. A class name of the input item may be added to the configuration if necessary. On the other hand, when an operation is aimed at a screen, screen operation data has a configuration composed of a recording category, a screen UID and a screen position. Discrimination between an operation aimed at a screen or an operation aimed at an input item can be made by the recording category.

FIG. 5 shows formats of class name lists according to an embodiment of the invention. The class name lists are configured as follows.

When a class name is included as a constituent element of the first screen information, a class name list is composed of the following class names in accordance with each development language used for creating or modifying a target program and each input item of a screen of the target program. That is, the class names are an individual class name of the input item at the time of the creation and the modification, an individual class name of the input item in one or both of operating modes (intermediate language mode and executable mode) of an execution code of the target program, and a representative class name of the input item.

On the other hand, when a class name is included as a constituent element of the screen operation data, a class name list is composed of the following class names in accordance with each development language used for creating or modifying a target program and each input item of a screen of the target program. That is, the class names are an individual class name of the input item in one or both of the operating modes of the execution code of the target program, and a representative class name of the input item.

Imagine an example where a class name is included as a constituent element of the first screen information.

In one operating mode (intermediate language mode) of the execution code, an individual class name A at the time of the creation and modification and an individual class name A in the intermediate language mode are constituent elements in a development language A. Likewise an individual class name B at the time of the creation and modification and an individual class name B in the intermediate language mode are constituent elements in a development language B.

In the other operating mode (executable mode) of the execution code, the individual class name A at the time of the creation and modification and an individual class name A in the executable mode are constituent elements in the development language A. Likewise the individual class name B at the time of the creation and modification and an individual class name B in the executable mode are constituent elements in the development language B.

In both operating modes (intermediate language mode and executable mode) of the execution code, the individual class name A at the time of the creation and modification and the individual class names A in the intermediate language mode and executable mode are constituent elements in the development language A. Likewise the individual class name B at the time of the creation and modification and the individual class names B in the intermediate language mode and executable mode are constituent elements in the development language B.

Due to some characteristic of a development language, the individual class name of an input item at the time of the creation and modification may be identical to the individual class name of the input item in an operating mode of the execution code. In this case, in a class name list, the individual class name of the input item at the time of the creation and modification and the individual class name of the input item in the operating mode can be integrated into one.

### EMBODIMENT

FIG. 6 is a flow chart showing a method for converting screen operation data (in the case where a screen or an input item is added or a screen OID or an item OID is changed when a target program is created or modified) according to an embodiment of the invention.

The process of FIG. 6 is activated whenever an event where a screen or an input item is added or an event where a screen OID or an item OID is changed occurs when a target program is created or modified.

When a screen is added to the target program (Step S11), a screen OID and a screen title of the screen are acquired and a new screen UID is attached thereto to form screen format data. The screen format data are stored in the second screen information in the recording means 5 (Step S12). Then, the processing of the event is terminated.

When an input item is added to a screen of the target program (Step S13), an item OID and item coordinates of the input item are acquired and a new item UID is attached thereto. When a class name is included as a constituent element of the first screen information, a class name of the input item is added. Input item format data formed thus are stored in the first screen information in the recording means 5 (Step S14). Then, the processing of the event is terminated.

When a screen OID of a screen of the target program is changed (Step S15), a before-change screen OID and an after-change screen OID of the screen are acquired. Format data having a screen OID coinciding with the before-change screen OID is identified from the second screen information in the recording means 5, and the screen OID of the format data is replaced by the after-change screen OID (Step S16). Then, the processing of the event is terminated.

When an item OID of an input item of the screen of the target program is changed (Step S17), a before-change item OID and an after-change item OID of the input item are acquired. Format data having an item OID coinciding with the before-change item OID is identified from the first screen information in the recording means 5, and the item OID of the format data is replaced by the after-change item OID (Step S18). Then, the processing of the event is terminated.

FIG. 7 is a flow chart showing a method for converting screen operation data (in the case where an external command is issued by pushing down a shortcut key in the input device 1 or by pointing on the display device 2 when a target program is created or modified, or in the case where creation or modification of the target program is terminated) according to an embodiment of the invention.

When the target program is created, the aforementioned external command may be issued (Step S21) or the creation of the target program may be terminated (Step S22). In this case, first, all the format data stored in the first screen information and the second screen information are deleted (Step S23).

Subsequently, all the screens and input items of the target program are listed up.

When the screens are listed up, the screen OID and screen title of each screen are acquired and a new screen UID is attached thereto. Screen format data formed thus are stored in the second screen information (Step S24).

On the other hand, when the input items are listed up, the item OID and item coordinates of each input item are acquired, and a new item UID is attached thereto. When a class name is included as a constituent element of the first screen information, a class name of the input item is added. Input item format data formed thus are stored in the first screen information (Step S24).

When the target program is modified, the aforementioned external command may be issued (Step S25) or the modification of the target program may be terminated (Step S26). In this case, all the screens and input items of the target program are listed up.

When the screens are listed up, the screen OID and screen title of each screen are acquired. When format data having a screen OID coinciding with the acquired screen OID are present in the second screen information (Step S27), the screen title of the format data is updated by the screen title of the screen (Step S28). When there are no format data corresponding to the screen (Step S27), format data of the screen formed by attaching a new screen UID thereto are stored in the second screen information (Step S29).

On the other hand, when the input items are listed up, the item OID and item coordinates of each input item are acquired. When format data having an item OID coinciding with the acquired item OID are present in the first screen information (Step S27), the item coordinates of the format data are updated by the item coordinates of the input item (Step S28). When there are no format data corresponding to the input item (Step S27), format data of the input item formed by attaching a new item UID thereto and adding a class name of the input item thereto if the class name is included as a constituent element of the first screen information are stored in the first screen information (Step S29).

FIG. 8 is a flow chart showing a method for converting screen operation data (when a screen operation is acquired) according to an embodiment of the invention. Processing from Step S41 to Step S44 in FIG. 8 is executed in Step S102, Step S105, Step S106, Step S109 and Step S111 in FIG. 14.

When screen operation data of a screen is stored in the storage device 3 in FIG. 14 at the time of acquisition of a screen operation (Step S102 and Step S106), the operation is aimed at the screen in FIG. 8 (step S41). Accordingly, a screen UID of format data having a screen title coinciding with the screen title of the screen is acquired from the second screen information, and the screen position of the screen is acquired. “Screen display” is written into the recording category. Screen operation data of the screen formed thus are stored in the storage device 3 (Step S42).

On the other hand, when screen operation data of an input item are stored in the storage device 3 in FIG. 14 (Step S105, Step S109 and Step S111) at the time of acquisition of a screen operation, the operation is aimed at the input item in FIG. 8. (Step S43). Accordingly, an item UID of format data having item coordinates coinciding with the item coordinates of the input item is acquired from the first screen information. When the input item has an item value, the item value is acquired. When a class name is included as a constituent element of the screen operation data, the class name of the input item is acquired. “Mouse operation” or “item value input” is written into the recording category. Screen operation data of the input item formed thus are stored in the storage device 3 (Step S44).

FIG. 9 is a flow chart showing a method for converting screen operation data (when a screen operation is reproduced) according to an embodiment of the invention. Processing from Step S51 to Step S54 in FIG. 9 is executed in Step S201 in FIG. 15.

When screen operation data are read from the storage device 3 in FIG. 15 (Step S201) at the time of reproduction of a screen operation, the following processing is performed in FIG. 9.

When the recording category of the read screen operation data is “screen display” (Step S51), the screen UID of the screen operation data is used so that a screen title of format data having a screen UID coinciding with the screen UID of the screen operation data is acquired from the second screen information. The screen title is used as a subject of comparison so that a screen having a screen title coinciding therewith is identified from screens drawn on the display device 2. The identified screen is specified as a screen to be reproduced (Step S52).

On the other hand, when the recording category of the read screen operation data is “item operation” of “mouse operation” or “item value input” (Step S53), no class name may be included in constituent elements of the first screen information and the screen operation data. In this case, item coordinates of format data having an item UID coinciding with the item UID of the screen operation data are acquired from the first screen information. The item coordinates are used as a subject of comparison so that an input item having item coordinates coinciding therewith is identified from input items drawn on the display device 2. The identified input item is specified as an input item to be reproduced (Step S54).

Alternatively, a class name may be included in constituent elements of the first screen information or the screen operation data. In this case, item coordinates of format data having an item UID coinciding with the item UID of the screen operation data are acquired from the first screen information. When a class name is included as a constituent element of the first screen information, the class name is acquired from the format data. When a class name is included as a constituent element of the screen operation data, the class name is acquired from the screen operation data. The class name and item coordinates acquired thus are used as a subject of comparison so that an input item having a class name and item coordinates coinciding therewith is identified from input items drawn on the display device 2. The identified input item is specified as an input item to be reproduced (Step S54).

FIG. 10 is a flow chart showing a method for converting a class name by using a class name list according to an embodiment of the invention when a target program is created or modified or when a screen operation is acquired. Step S61 to Step S63 in FIG. 10 are executed in Step S14 in FIG. 6 and Step S44 in FIG. 8.

When a target program is created or modified, input item format data are stored in the first screen information in FIG. 6 (Step S14). When a class name is included as a constituent element of the first screen information, a class name of the format data to be stored is used as an individual class name. In FIG. 10, this individual class name is used so that data having an individual class name coinciding therewith are identified from individual class names read (Step S61) from the column of individual class names at the time of the creation and modification in the class name list (Step S62). A representative class name of the identified data is acquired (Step S63). The acquired representative class name is used as a class name of the format data to be stored in the first screen information.

When a screen operation is acquired, screen operation data of an input item are stored in the storage device 3 in FIG. 8 (Step S44). When a class name is included as a constituent element of the screen operation data, the class name of the screen operation data to be stored is used as an individual class name. In FIG. 10, this individual class name is used so that data having an individual class name coinciding therewith are identified from individual class names read (Step S61) from the column of an operating mode of the execution code of the target program at the time of acquisition in the class name list (Step S62). A representative class name of the identified data is acquired (Step S63). The acquired representative class name is used as a class name of the screen operation data to be stored in the storage device 3.

Incidentally, the operating mode of the execution code is identified based on an operating mode designated manually or based on the class name automatically. (For example, in the language of Visual Basic (registered trademark) 6.0 by Microsoft Corporation, an operating mode with a class name added with RT6 is determined as an executable mode, and an operating mode with a class name not added with RT6 is determined as an intermediate language mode.)

FIG. 11 is a flow chart showing a method for converting a class name by using a class name list according to an embodiment of the invention when a screen operation is reproduced. Step S71 to Step S73 in FIG. 11 are executed in Step S54 in FIG. 9.

When a screen operation is reproduced, an input item to be reproduced is specified in FIG. 9 (Step S54).

When a class name is included as a constituent element of screen operation data, the class name of the screen operation data read from the storage device 3 is used as a representative class. In FIG. 11, the representative class name is used so that data having a representative class name coinciding therewith are identified from representative class names read (Step S71) from the class name list (Step S72). An individual class name is acquired from the column of an operating mode of the execution code of the target program at the time of reproduction (Step S73). The acquired individual class name is used as a class name to be compared.

Alternatively, when a class name is included as a constituent element of the first screen information, the class name of format data acquired from the first screen information by using an item UID of the screen operation data read from the storage device 3 is used as a representative class. In FIG. 11, the representative class name is used so that data having a representative class name coinciding therewith are identified from representative class names read (Step S71) from the class name list (Step S72). An individual class name is acquired from the column of an operating mode of the execution code of the target program in reproduction (Step S73). The acquired individual class name is used as a class name to be compared.

Incidentally, the operating mode of the execution code is identified based on an operating mode specified manually or based on the class name automatically. (For example, in the language of Visual Basic (registered trademark) 6.0 by Microsoft Corporation, an operating mode with a class name added with RT6 is determined as an executable mode, and an operating mode with a class name not added with RT6 is determined as an intermediate language mode.)

FIG. 12 is a flow chart showing a method for interpreting a source code of a target program and activating an execution code of an intermediate language mode directly according to an embodiment of the invention when a screen operation is acquired or reproduced.

A development language for creating an execution code of a target program may have not been activated yet (Step S81).

In this case, first, a path to the development language is acquired from a first system specific area such as a registry storing the path to the development language (for example, HKEY_CLASSES_ROT¥¥Applications¥¥vb6.exe¥¥shell¥¥open¥¥Comm and in the language of Visual Basic (registered trademark) 6.0 by Microsoft Corporation) using a first system specific command (for example, RegOpenKeyEx command in the environment of Windows (registered trademark) by Microsoft Corporation) (Step S82).

Next, a path to a source code of the target program used last is acquired from a second system specific area such as a registry storing the path to the source code (for example, in the language of Visual Basic (registered trademark) 6.0 by Microsoft Corporation, HKEY_CURRENT_USER¥¥Software¥¥Microsoft¥¥VisualBasic¥¥6.0¥¥ recent files) using the first system specific command (Step S83).

Finally, the path to the development language and the path to the source code are specified, and a command to activate the development language is issued to the software environment by use of a second system specific command (for example, ShellExecute command in the environment of Windows (registered trademark) by Microsoft Corporation) (Step S84).

In the case where the development language is activated (Step S81) or has been activated (Step S85), a command to interpret the source code into the execution code is issued by a third system specific command (for example, Send Input command in the environment of Windows (registered trademark) by Microsoft Corporation) (Step S86) when the target program is being displayed on the foreground of the screen. Thus, the source code is interpreted into the execution code, and the execution code of the intermediate language mode is activated.

### INDUSTRIAL APPLICABILITY

With the development of information technology, importance of information systems as social infrastructure has been expanded. Thus, ability to develop and maintain high-quality software has been required. In reality, however, checking of operations in the information systems is still performed mainly by labor-intensive techniques based on manual procedures. Time and effort (time and man-hour) of the manual procedures are so immense that perfectly satisfactory checking of operations cannot be performed. The information systems are started or restarted in this state, thereby resulting in various troubles. Therefore, needs of automated checking of operations in the information systems are vast but the burden in using an operation checking system is heavy in the background art. According to the present invention, the burden in using an operation checking system is lightened to accelerate the use of the operation checking system.

### BRIEF DESCRIPTION OF THE DRAWINGS

FIG. 1 A diagram showing a configuration of an operation checking system in an information system according to an embodiment of the invention.

FIG. 2 A diagram showing the function of the operation checking system in the information system according to the embodiment of the invention.

FIG. 3 A diagram showing structures of first screen information and second screen information according to the embodiment of the invention.

FIG. 4 A diagram showing a structure of screen operation data according to the embodiment of the invention.

FIG. 5 A diagram showing structures of class name lists according to the embodiment of the invention.

FIG. 6 A flow chart showing a method for converting the screen operation data according to the embodiment of the invention (in the case where a screen or an input item is added or an object identifier of the screen or the input item is changed when a target program is being created or modified).

FIG. 7 A flow chart showing a method for converting the screen operation data according to the embodiment of the invention (in the case where an external command is issued when the target program is created or modified, or in the case where creation or modification of the target program is terminated)

FIG. 8 A flow chart showing a method for converting the screen operation data according to the embodiment of the invention (when a screen operation is acquired).

FIG. 9 A flow chart showing a method for converting the screen operation data according to the embodiment of the invention (when a screen operation is reproduced).

FIG. 10 A flow chart showing a method for converting a class name according to the embodiment of the invention (when a target program is created or modified or when a screen operation is acquired).

FIG. 11 A flow chart showing a method for converting a class name according to the embodiment of the invention (when a screen operation is reproduced).

FIG. 12 A flow chart showing a method for interpreting a source code of a target program and activating an execution code of an intermediate language mode directly according to the embodiment of the invention.

FIG. 13 A diagram showing a structure of a test script in a general example in the background art.

FIG. 14 A flow chart showing a method for acquiring a screen operation in a general example in the background art.

FIG. 15 A flow chart showing a method for reproducing a screen operation in a general example in the background art.

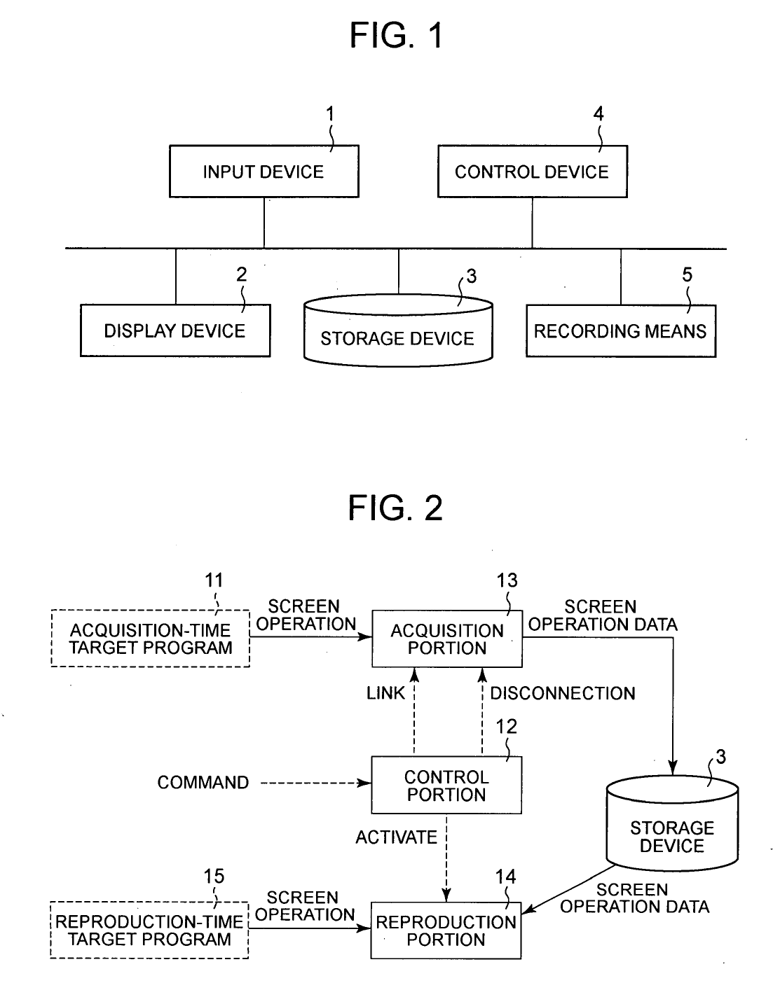

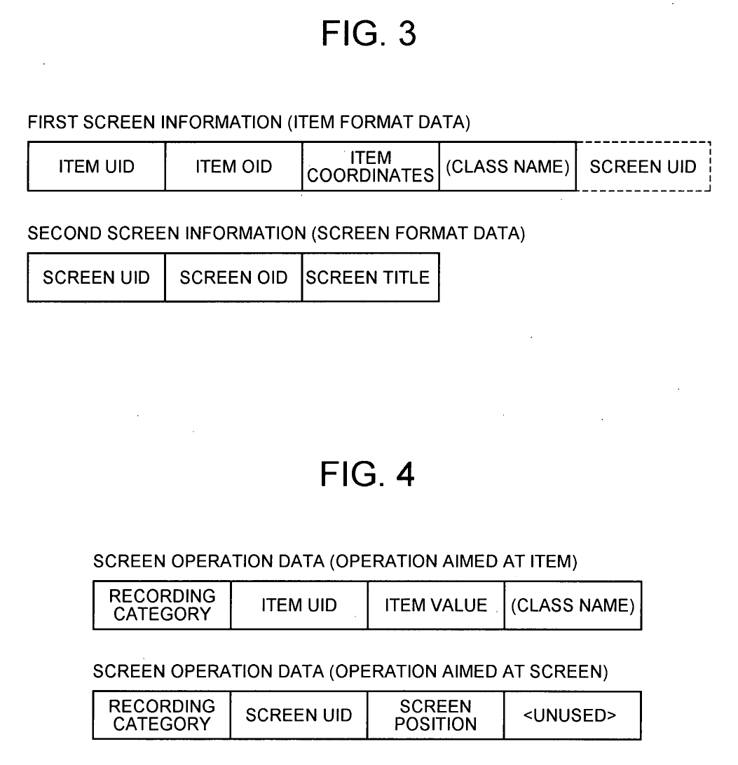

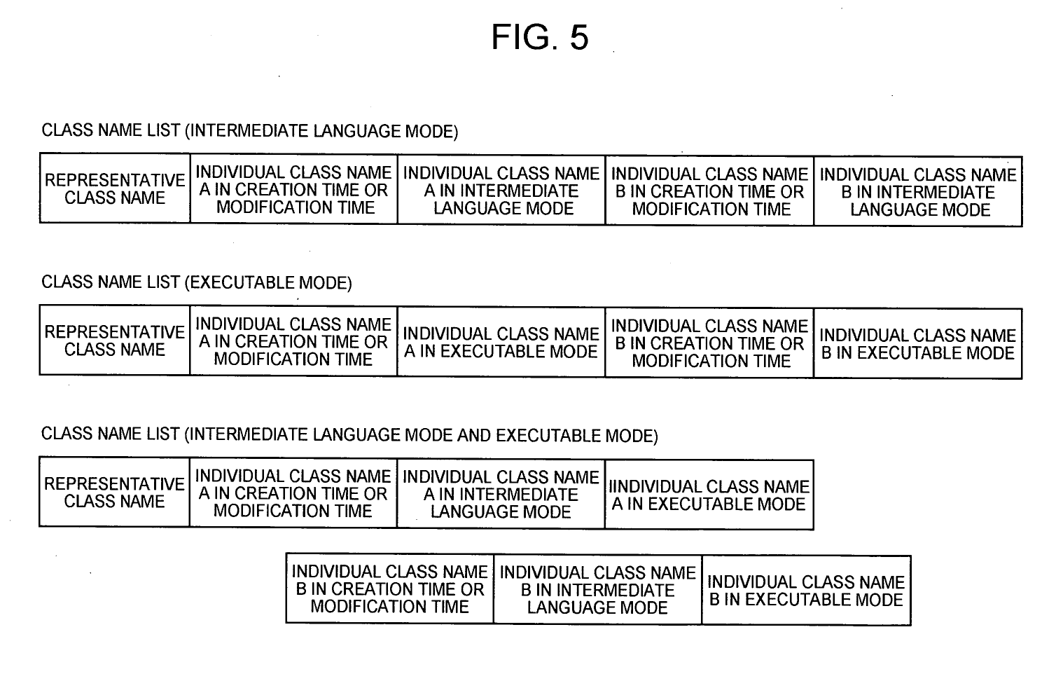

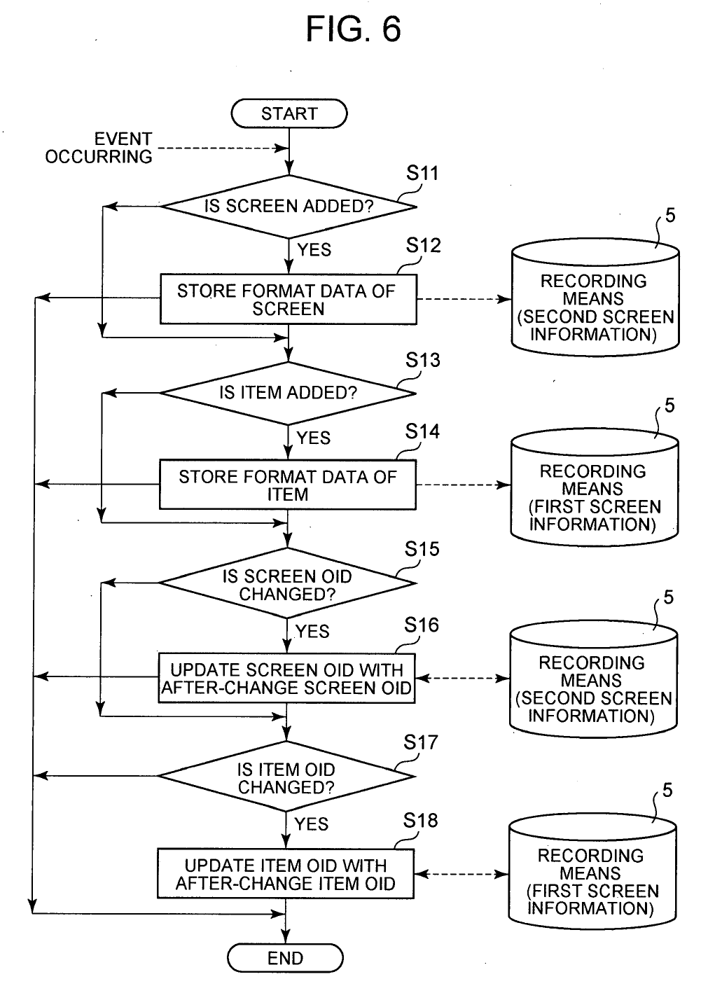

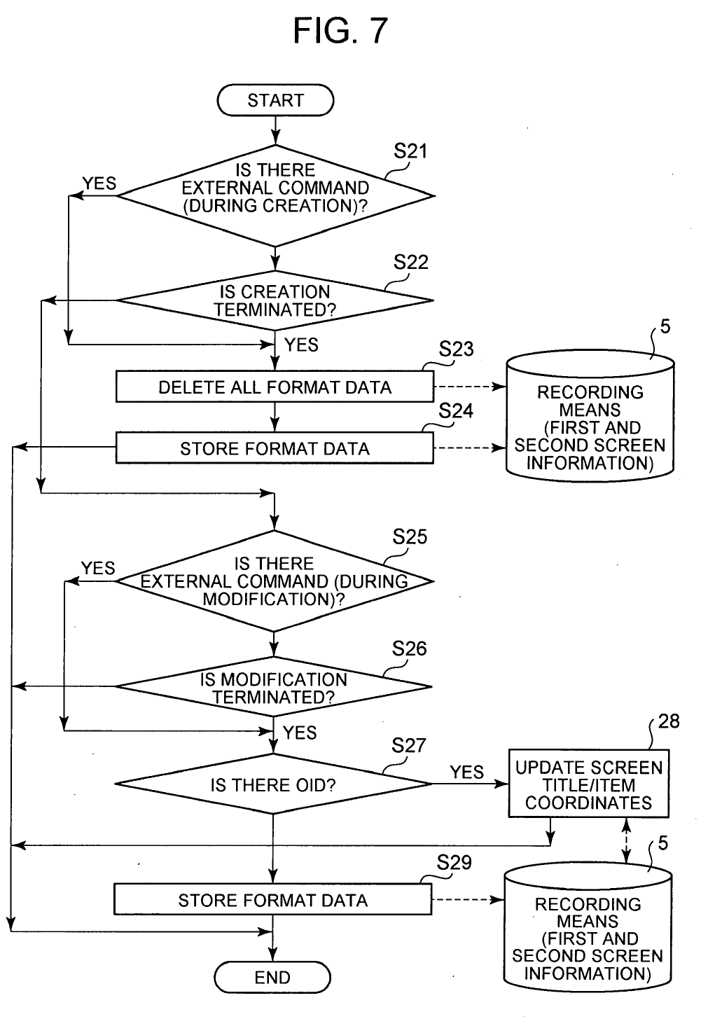

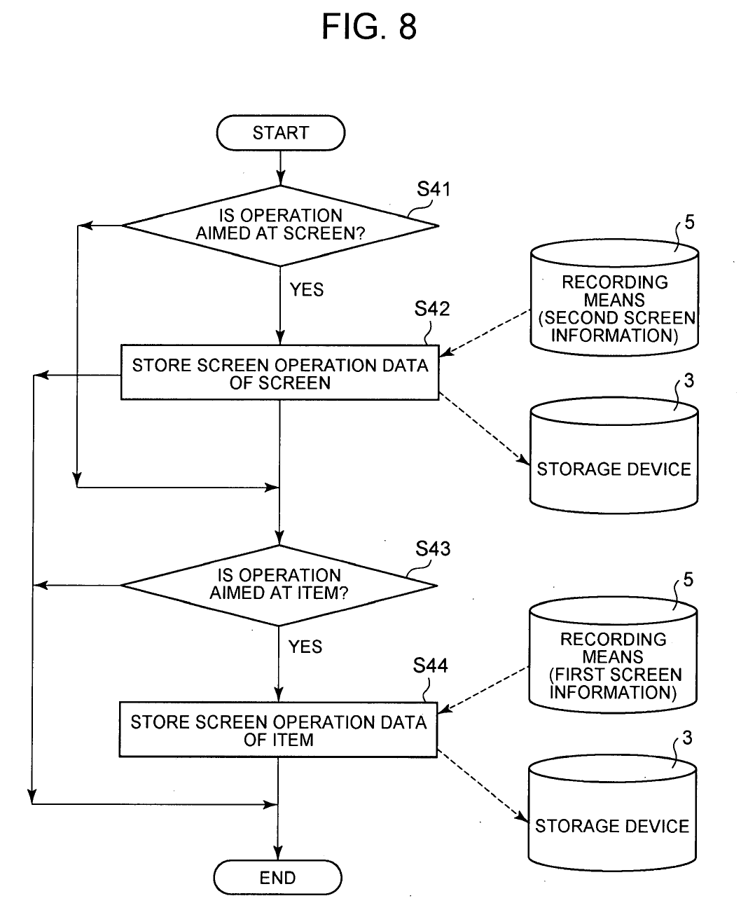

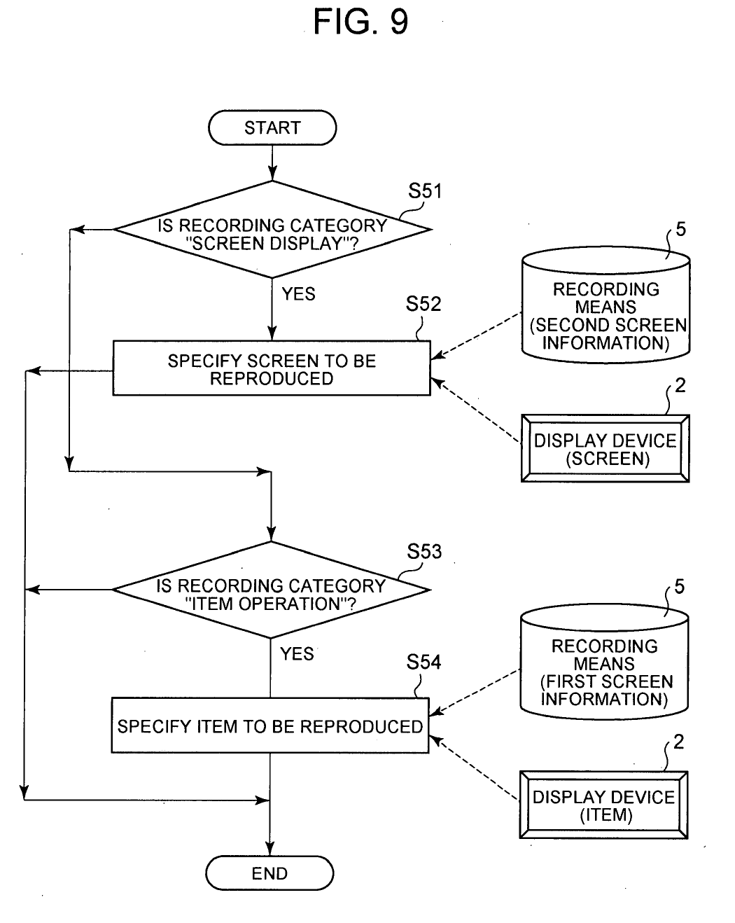

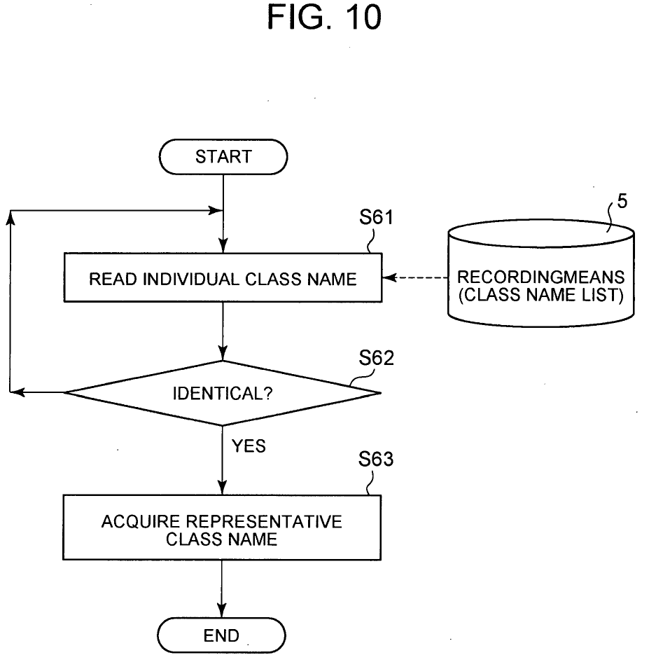

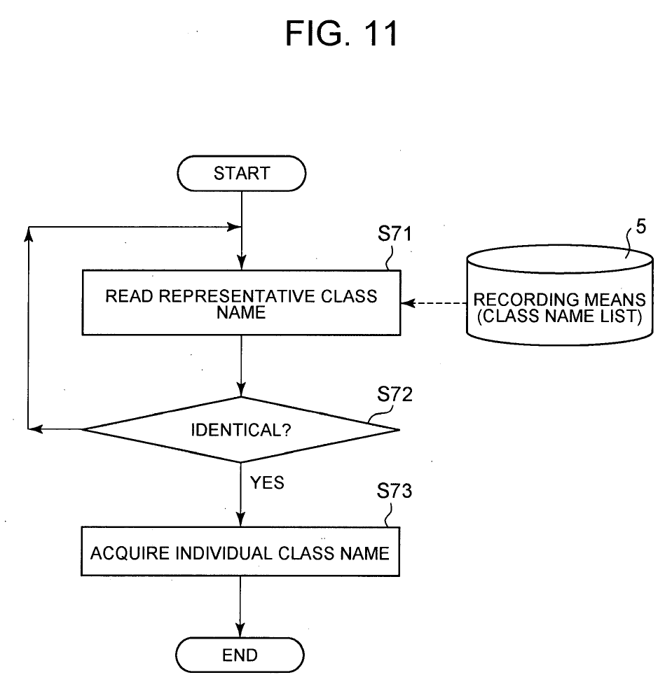

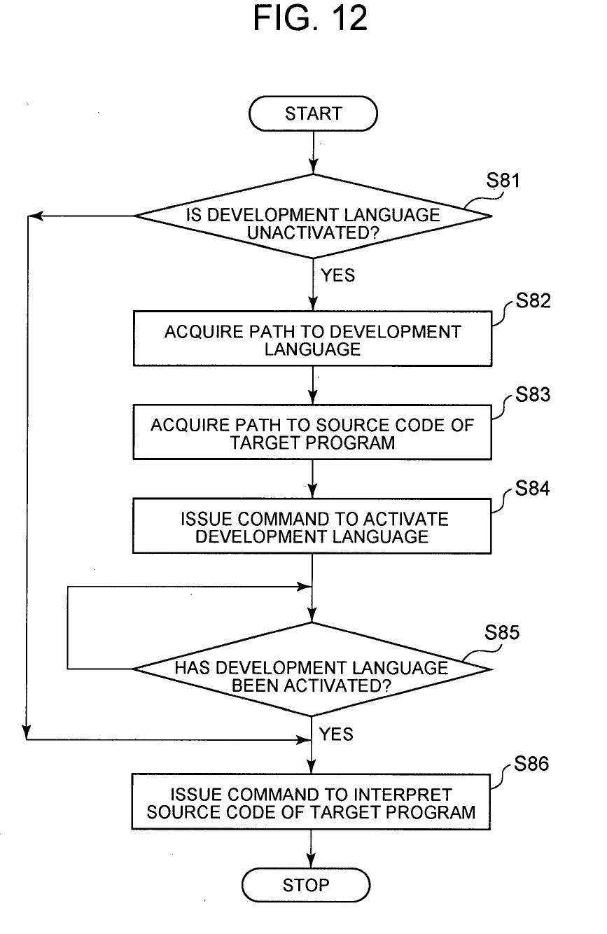

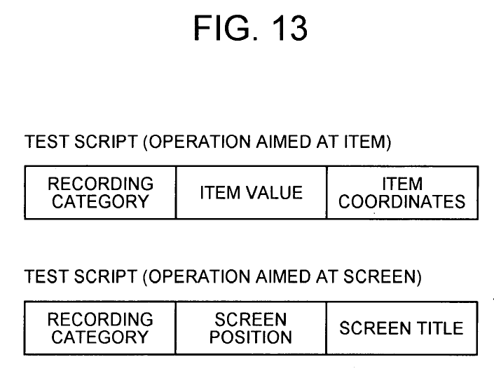

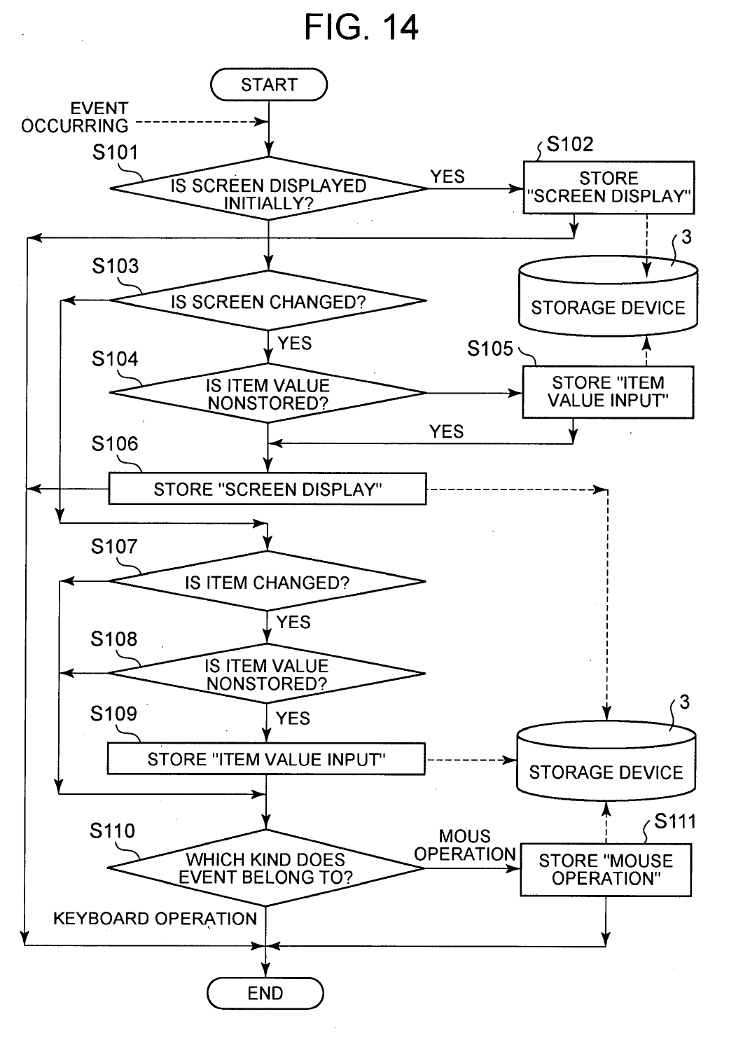

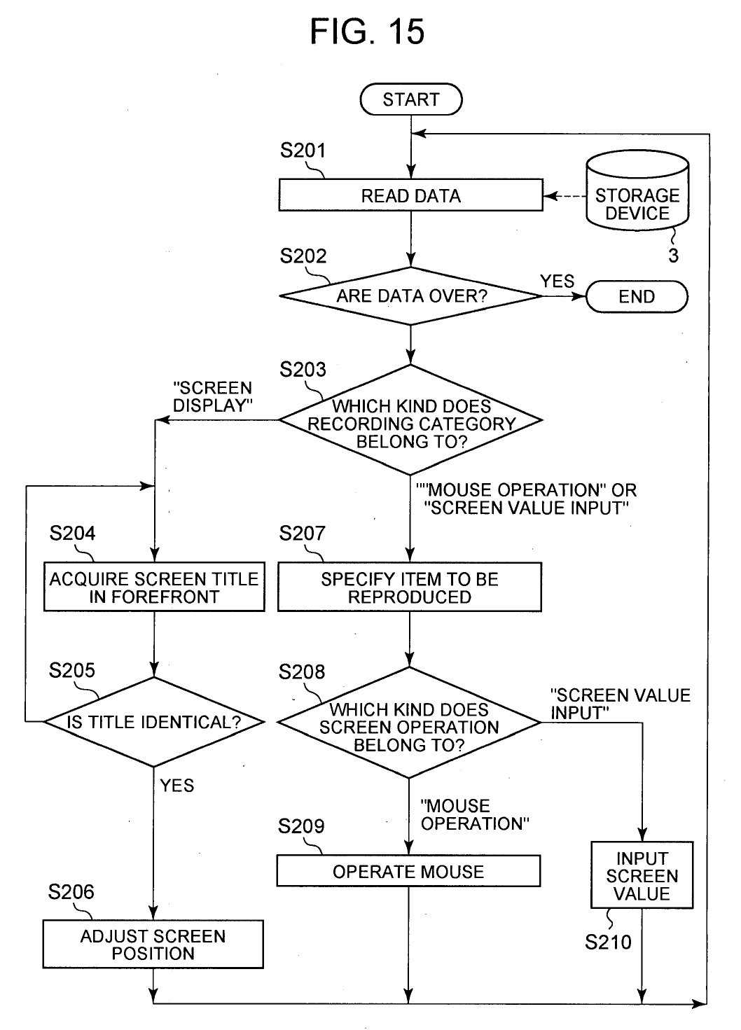

### DESCRIPTION OF REFERENCE NUMERALS

1 input device constituted by keyboard, pointing device, etc.
2 display device constituted by display or the like
3 storage device for storing or reading screen operation data
4 control device for executing control according to the invention
5 recording means for storing control information etc. required for the control according to the invention
11 target program when screen operation is acquired
12 control portion
13 acquisition portion
14 reproduction portion
15 target program at the time of reproduction of screen operation

1. An operation checking method in an information system in which screen operation data obtained by acquiring a screen operation executed on a display device by using a hardware environment, a software environment and a target program before change of any one of the hardware environment, the software environment and the target program are stored in a storage device, and the screen operation data are read from the storage screen and the screen operation is reproduced on the display device after change of any one of the hardware environment, the software environment and the target program, the operation checking method comprising the steps of:
performing one or both of the following processes at the time of creation or modification of the target program,
a process of storing, in first screen information, format data formed by acquiring an object identifier and item coordinates of an input item and attaching a new item unique identifier thereto, when the input item is added into a screen of the target program, and
a process of storing, in the first screen information, format data formed by listing up all input items of the target program, acquiring an object identifier and item coordinates of each input item and attaching a new item unique identifier thereto, when an external command is issued by a shortcut key pushed down in an input device or by pointing on the display device or when creation or modification of the target program is terminated;
storing, in the storage device, screen operation data formed by identifying format data having item coordinates coinciding with item coordinates of an input item from the first screen information, acquiring an item unique identifier of the format data and putting a kind of operation corresponding to the input item into a recording category, when the screen operation acquired at the time of acquisition of the screen operation is an operation aimed at the input item; and
specifying the input item as an input item to be subjected to reproduction of the screen operation by using an item unique identifier of the screen operation data for identifying format data having an item unique identifier coinciding with the item unique identifier of the screen operation data from the first screen information and by using item coordinates acquired from the format data as a subject of comparison for identifying an input item having item coordinates coinciding therewith from input items drawn on the display device, when a recording category of screen operation data read from the storage device at the time of reproduction of the screen operation shows an operation aimed at the input item.

2. An operation checking method in an information system according to claim 1, further comprising the steps of:
identifying format data having an object identifier coinciding with a before-change object identifier of an input item from the first screen information and changing a value of the object identifier of the format data to a value of an after-change object identifier of the input item, when the object identifier of the input item is changed at the time of creation or modification of the target program; and
storing, in the first screen information, format data formed by listing up all input items of the target program, acquiring an object identifier and item coordinates of each input item, changing values of item coordinates of the format data into values of the item coordinates of the input item when format data having an object identifier coinciding with the acquired object identifier show an input item present in the first screen information, acquiring an object identifier and item coordinates of the input item when the format data show an input item absent in the first screen information, and attaching a new item unique identifier thereto, when the external command is issued at the time of creation or modification of the target program or when creation or modification of the target program is terminated.

3. An operation checking method in an information system according to claim 1, further comprising the steps of:
when a class name is included as a constituent element of the first screen information,
adding a class name of the added input item or class names of the listed input items into a configuration of the format data to be stored in the first screen information at the time of creation or modification of the target program; and
specifying the input item as an input item to be subjected to reproduction of the screen operation at the time of reproduction of the screen operation by using an item unique identifier of screen operation data read from the storage device for identifying format data having an item unique identifier coinciding with the item unique identifier of the screen operation data from the first screen information and by using item coordinates and a class name acquired from the identified format data as item coordinates and a class name to be compared for identifying an input item having item coordinates and a class name coinciding therewith from input items drawn on the display device.

4. An operation checking method in an information system according to claim 1, further comprising the steps of:
when a class name is included as a constituent element of the screen operation data,
adding a class name of the acquired input item to be subjected to the screen operation into a configuration of the screen operation data to be stored in the storage device at the time of acquisition of the screen operation; and
specifying the input item as an input item to be subjected to reproduction of the screen operation at the time of reproduction of the screen operation by using an item unique identifier of screen operation data read from the storage device for identifying format data having an item unique identifier coinciding with the item unique identifier of the screen operation data from the first screen information and by using item coordinates acquired from the identified format data and a class name acquired from the screen operation data as item coordinates and a class name to be compared for specifying an input item having item coordinates and a class name coinciding therewith from input items drawn on the display device.

5. An operation checking method in an information system according to claim 3, further comprising the steps of:
when a class name is included as a constituent element of the first screen information,
using a class name list composed of an individual class name of each input item at the time of creation and modification of the target program, an individual class name of the input item in one or both of operating modes of an execution code of the target program and a representative class name of the input item in accordance with each development language used for creating or modifying the target program and each input item of a screen of the target program;
using a class name of the added input item or a class name of each of the listed input items as an individual class name, identifying data having an individual class name coinciding therewith from a column of creation-time or modification-time individual class names in the class name list by using the individual class name, acquiring a representative class name of the identified data and using the acquired representative class name as a class name to be added to a configuration of format data to be stored in the first screen information, at the time of creation or modification of the target program; and
using a class name acquired from the format data as a representative class name, identifying data having a representative class name coinciding therewith from a column of representative class names in the class name list by using the representative class name, acquiring an individual class name from a column of reproduction-time individual class names in an operating mode of the execution code of the target program and using the acquired individual class name as a class name to be used as the class name to be compared, at the time of reproduction of the screen operation.

6. An operation checking method in an information system according to claim 4, further comprising the steps of:
when a class name is included as a constituent element of the screen operation data,
using a class name list composed of an individual class name of each input item and a representative class name of the input item in one or both of operating modes of an execution code of the target program in accordance with each development language used for creating or modifying the target program and each input item of a screen of the target program;
using a class name of the acquired input item to be subjected to the screen operation as an individual class name, identifying data having an individual class name coinciding therewith from a column of acquisition-time class names in an operating mode of an execution code of the target program in the class name list by using the individual class name, acquiring a representative class name of the identified data and using the acquired representative class name as a class name to be added to a configuration of screen operation data to be stored in the storage device, at the time of acquisition of the screen operation; and
using a class name acquired from the screen operation data as a representative class name, identifying data having a representative class name coinciding therewith from a column of representative class names in the class name list by using the representative class name, acquiring an individual class name from a column of reproduction-time individual class names in an operating mode of the execution code of the target program and using the acquired individual class name as a class name to be used as the class name to be compared, at the time of reproduction of the screen operation.

7. An operation checking method in an information system according to claim 1, further comprising the steps of:
executing a first system specific command to acquire a path to a development language from a first system specific area and acquire a path to a source code of the target program from a second system specific area and executing a second system specific command by using the path to the development language and the path to the source code to instruct the software environment to activate the development language when the development language for creating an execution code of the target program has not been activated yet at the time of acquisition or reproduction of the screen operation; and
executing a third system specific command in the middle of display of the target program in the foreground of a screen to instruct the software environment to interpret the source code of the target program into the execution code to activate the execution code of the target program to use the execution code as a target program to be used at the time of acquisition or reproduction of the screen operation when the development language has been activated.

8. An operation checking method in an information system according to claim 1, further comprising the steps of:
performing one or both of the following processes at the time of creation or modification of the target program,
a process of storing, in second screen information, format data formed by acquiring an object identifier and a screen title of a screen and attaching a new screen unique identifier thereto when the screen is added to the target program, and
a process of storing, in the second screen information, format data formed by listing up all screens of the target program, acquiring an object identifier and a screen title of each screen and attaching a new screen unique identifier thereto when the external command is issued or when creation or modification of the target program is terminated;
storing, in the storage device, screen operation data formed by identifying format data having a screen title coinciding with a screen title of the screen from the second screen information by using the screen title of the screen, acquiring a screen unique identifier of the format data and putting the kind of operation corresponding to the screen into a recording category when the screen operation acquired is an operation aimed at a screen at the time of acquisition of the screen operation; and
specifying the screen as a target screen to be subjected to reproduction of the screen operation by using a screen unique identifier of the screen operation data for identifying format data having a screen unique identifier coinciding with the screen unique identifier of the screen operation data from the second screen information and by using a screen title acquired from the identified format data as a screen title to be compared for identifying a screen having a screen title coinciding therewith from screens drawn on the display device when a recording category of the screen operation data read from the storage device shows an operation aimed at a screen at the time of reproduction of the screen operation.

9. An operation checking method in an information system according to claim 8, further comprising the steps of:
identifying format data having an object identifier coinciding with a before-change object identifier of the screen from the second screen information by using the before-change object identifier of the screen and changing a value of the object identifier of the identified format data into a value of an after-change object identifier of the screen when the object identifier of the screen is changed at the time of creation or modification of the target program; and
storing, in the second screen information, format data formed by listing up all screens of the target program, acquiring an object identifier and a screen title with respect to each screen, changing a value of a screen title of the format data into a value of the screen title of the screen when format data having an object identifier coinciding with the acquired object identifier are present in the second screen information, acquiring an object identifier and a screen title of the screen when the format data are absent in the second screen information, and attaching a new screen unique identifier thereto, when the external command is issued at the time of creation or modification of the target program or when creation or modification of the target program is terminated.

10. An operation checking program for implementing an operation checking method in an information system according to claim 1.

11. A computer-readable recording medium in which an operation checking program according to claim 10 is recorded.

12. An operation checking system wherein operation checking in an information system is made by using an operation checking program according to claim 10.
